(19) United States
(12) Patent Application Publication
(10) Pub. No.: US 2008/0235182 A1
(43) Pub. Date: Sep. 25, 2008

(54) Isolating Database Queries for Performance Processing

(76) Inventors: Shawn J. Baranczyk, Rochester, MN (US); Paul R. Day, Rochester, MN (US); Brian R. Muras, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/690,404

(22) Filed: Mar. 23, 2007

(51) Int. Cl. G06F 17/30

(52) U.S. Cl. 707/2; 707/E17.017

(57) ABSTRACT

Methods, systems, and computer program products are provided for isolating database queries for performance processing. Embodiments typically include presenting to a user a prioritized list of potentially poorly performing queries; receiving from the user a selection of one or more potentially poorly performing queries; and executing performance processing of the selected queries.

### BACKGROUND OF THE INVENTION

1. Field of the Invention

The field of the invention is data processing, or, more specifically, methods, apparatus, and products for isolating database queries for performance processing.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Information stored on a computer system is often organized in a structure called a database. A database is a grouping of related structures called ‘tables,’ which in turn are organized in rows of individual data elements. The rows are often referred to as ‘records,’ and the individual data elements are referred to as ‘fields.’ In this specification generally, therefore, an aggregation of fields is referred to as a ‘data structure’ or a ‘record,’ and an aggregation of records is referred to as a ‘table.’ An aggregation of related tables is called a ‘database.’

A computer system typically operates according to computer program instructions in computer programs. A computer program that supports access to information in a database is typically called a database management system or a ‘DBMS.’ A DBMS is responsible for helping other computer programs access, manipulate, and save information in a database.

A DBMS typically supports access and management tools to aid users, developers, and other programs in accessing information in a database. One such tool is the structured query language, ‘SQL.’ SQL is query language for requesting information from a database. Although there is a standard of the American National Standards Institute (‘ANSI’) for SQL, as a practical matter, most versions of SQL tend to include many extensions. Here is an example of a database query expressed in SQL:
select*from stores, transactions
where stores.location=“Minnesota”
and stores.storeID=transactions.storeID

This SQL query accesses information in a database by selecting records from two tables of the database, one table named ‘stores’ and another table named ‘transactions.’ The records selected are those having value “Minnesota” in their store location fields and transactions for the stores in Minnesota. In retrieving the data for this SQL query, an SQL engine will first retrieve records from the stores table and then retrieve records from the transaction table. Records that satisfy the query requirements then are merged in a ‘join.’

Application developers frequently have to debug various performance problems with Structured Query Language (SQL)—from application usage problems, poor index configurations, poor system/environment configurations, to DBMS or application defects. In a live environment, the rate of SQL queries per second may be very high (many thousands), and thus it is very hard for a user to stop the right job with the right query they intend to investigate. In dynamic SQL environments, the user may not even know when and from where the exact statements are issued, making the investigation very difficult.

The problem also exists for developers of the DBMS in the various components such as the parser, optimizer, engine, and contributes to high amount of resources spent fixing customer problems when there are thousands of jobs and thousands of queries per job that must be scrutinized to find the problem query in question.

Conventional analysis tools such as IBM's Visual Explain can capture information about queries and query implementations. Such conventional analysis tools are useful to pinpoint the location of a performance defect. It is often the case that users will run multiple queries in a job where one or more of the queries run poorly. In order to identify performance defects, the user must first start a performance monitor and then run the entire job to completion. The monitor generates a monitor file which is then imported into a tool that lists the explainable queries that can be retrieved from the file.

Because conventional analysis tools are run as a separate application and gather data about many queries at one time, such analysis tools do not provide the option of focusing on a particular query at run time in order to try various performance adjustments, or to debug the query at run time. For example, a typical Visual Explain diagram of an application may have hundreds and thousands of query statements. A Visual Explain filter can be applied to narrow these down so that one can find a query of interest, such as to display only queries that run more than 10 seconds, but this is after the query is run and therefore too late to focus on that query during its actual run, such as to apply a performance option, database monitor, or to debug that query during the next time it is run.

### SUMMARY OF THE INVENTION

Methods, systems, and computer program products are provided for isolating database queries for performance processing. Embodiments typically include presenting to a user a prioritized list of potentially poorly performing queries; receiving from the user a selection of one or more potentially poorly performing queries; and executing performance processing of the selected queries.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for isolating database queries for performance processing according to embodiments of the present invention.

FIG. 2 sets forth a block diagram of an exemplary system for isolating database queries for performance processing in accordance with the present invention according to embodiments of the present invention.

FIG. 3 sets forth a block diagram of automated computing machinery comprising a computer useful in isolating database queries for performance processing in accordance with the present invention.

FIG. 4 sets forth a flow chart illustrating an exemplary method for isolating database queries for performance processing according to embodiments of the present invention.

FIG. 5 sets forth a flow chart illustrating an exemplary method for presenting to a user a prioritized list of potentially poorly performing queries.

FIG. 6 sets forth a flow chart illustrating another exemplary method for presenting to a user a prioritized list of potentially poorly performing queries.

### DETAILED DESCRIPTION OF EXEMPLARY EMBODIMENTS

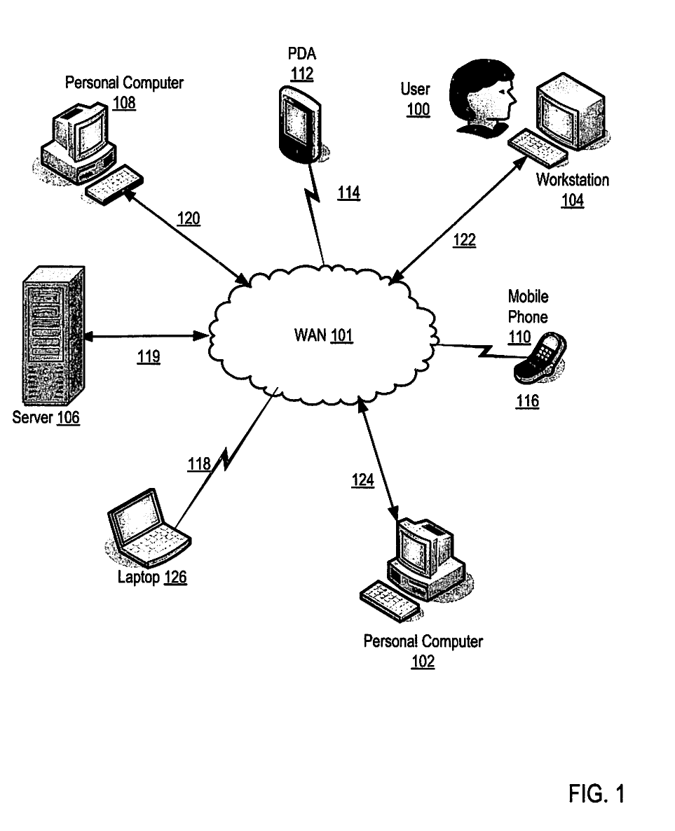

Exemplary methods, apparatus, and products for isolating database queries for performance processing in accordance with the present invention are described with reference to the accompanying drawings, beginning with FIG. 1. FIG. 1 sets forth a network diagram of a system for isolating database queries for performance processing according to embodiments of the present invention. The system of FIG. 1 operates generally to isolate database queries for performance processing by presenting to a user a prioritized list of potentially poorly performing queries; receiving from the user a selection of one or more potentially poorly performing queries; and executing performance processing of the selected queries. Executing performance processing of the selected queries may be carried out by executing performance analysis of the selected queries, such as by use of a performance analysis tool such as Visual Explain. Alternatively, executing performance processing of the selected queries may be carried out by executing performance tuning of the selected queries, such as by providing hints through functions such as Change Query Attributes or ‘CHGQRYA’ in a database management system. Isolating database queries for performance processing in accordance with the present invention efficiently allows a user to focus on potential problem queries and apply adjustments such as suggesting better indexes, rewriting the query, or even beginning a debug session on the query before it is run, without regard to such considerations as the SQL interface, application, job, user, pool, location and so on.

Presenting to a user a prioritized list of potentially poorly performing queries may be carried out, for example, in a SQL module of a database management system capable of receiving a plurality of queries; identifying one or more metrics describing the queries; ordering the queries in dependence upon the metrics; and displaying the ordered queries. Many different metrics may be used to order the queries. Examples of such metrics include absolute performance, performance relative to other runs of the same query, number of access plan rebuilds, number of Full Opens as opposed to pseudo opens, age of the query, number and type of negative SQL codes returned from the query, and others as will occur to those of skill in the art. Such a prioritized list of potentially poorly performing queries may also be updated as new queries are received. In such cases, presenting to a user a prioritized list of potentially poorly performing queries may also include receiving a new query; identifying one or more metrics describing the new query; and inserting the query in a prioritized list of queries in dependence upon the metrics. A current prioritized list of potentially poorly performing queries may therefore be maintained.

A prioritized list of poorly performing queries allows a user to select from the prioritized list a particular query and execute performance processing on only the selected queries. The performance processing of the selected queries may occur upon receiving the selected query, such as the next time the query is run without further user interaction. Alternatively, executing performance processing of the selected queries may include prompting the user for an instruction to execute a performance processing tool for the selected query upon receiving the selected query. Prompting the user provides notice to the user that the selected query has been received and performance processing tools are being executed on the isolated query.

FIG. 1 depicts an exemplary data processing system capable of isolating database queries for performance processing according to embodiments of the present invention. The system of FIG. 1 includes a number of computers connected for data communications in networks. Each of the computers of the system of FIG. 1 may have installed upon it a database management system capable of isolating database queries for performance processing in accordance with the present invention. The data processing system of FIG. 1 includes wide area network (“WAN”) (101). The network connection aspect of the architecture of FIG. 1 is only for explanation, not for limitation. In fact, systems for isolating database queries for performance processing according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, several exemplary devices including a PDA (112), a computer workstation (104), a mobile phone (110), personal computer (102), a laptop (126), a server (106), and another personal computer (108) are connected to WAN (101). The network-enabled mobile phone (110) connects to WAN (101) through wireless link (116), the PDA (112) connects to network (101) through wireless link (114) and the laptop (126) connects to the network (101) through a wireless link (118). In the example of FIG. 1, the personal computer (108) connects through a wireline connection (120) to WAN (101), the computer workstation (104) connects through a wireline connection (122) to WAN (101), the personal computer (108) connects through a wireline connection (124) to WAN (101), and the server (106) connects through a wireline connection (119) to WAN (101).

In the system of FIG. 1, exemplary devices (120, 112, 104, 106, 110, 126, and 102) support a database management system capable of isolating database queries for performance processing by presenting to a user (100) a prioritized list of potentially poorly performing queries; receiving from the user (100) a selection of one or more potentially poorly performing queries; and executing performance processing of the selected queries.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

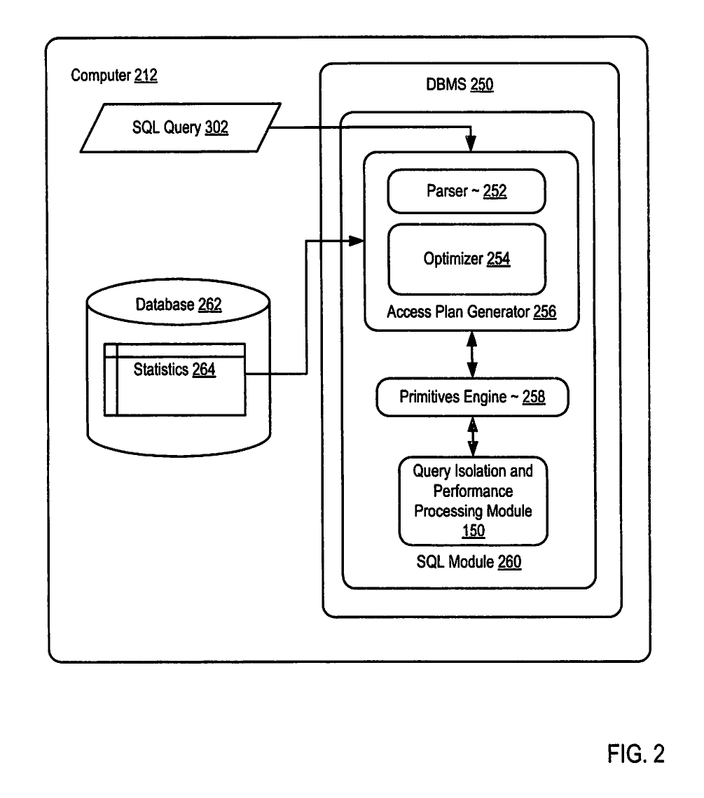

For further explanation, FIG. 2 sets forth a block diagram of an exemplary system for isolating database queries for performance processing in accordance with the present invention according to embodiments of the present invention. The system of FIG. 2 includes a computer (212) having installed upon it a database management system (‘DBMS’) (250). DBMS (250) administers access to the contents of the database (262). The DBMS (250) includes an SQL module (260). The SQL module is implemented as computer program instructions that execute a SQL query (302).

The exemplary SQL module (260) of FIG. 2 also includes an exemplary access plan generator (256). Each SQL query is carried out by a sequence of database operations specified as an access plan. The access plan generator of FIG. 2 is implemented as computer program instructions that create an access plan for a SQL query. An access plan is a description of database functions for execution of an SQL query. Taking the following SQL query as an example:
select*from stores, transactions
where stores.storeID=transactions.storeID,
   access plan generator (256) may generate the following exemplary access plan for this SQL query:
tablescan stores
join to
index access of transactions

This access plan represents database functions to scan through the stores table and, for each stores record, join all transactions records for the store. The transactions for a store are identified through the storeID field acting as a foreign key. The fact that a selection of transactions records is carried out for each store record in the stores table identifies the join function as iterative.

The exemplary access plan generator (256) of FIG. 2 includes a parser (252) for parsing the SQL query. Parser (252) is implemented as computer program instructions that parse the SQL query. A SQL query is presented to SQL module (260) in text form, the parameters of an SQL command. Parser (252) retrieves the elements of the SQL query from the text form of the query and places them in a data structure more useful for data processing of an SQL query by an SQL module.

The exemplary access plan generator (256) also includes an optimizer (254) implemented as computer program instructions that optimize the access plan in dependence upon database management statistics (264). Optimizer (254) optimizes the execution of SQL queries against DBMS (250). Optimizer (254) is implemented as computer program instructions that optimize execution of a SQL query in dependence upon database management statistics (264). Database statistics are typically implemented as metadata of a table, such as, for example, metadata of tables of database (262) or metadata of database indexes. Database statistics may include, for example:
histogram statistics: a histogram range and a count of values in the range,
frequency statistics: a frequency of occurrence of a value in a column, and
Cardinality statistics: a count of the number of different values in a column.

These three database statistics are presented for explanation only, not for limitation.

The exemplary SQL module (260) of FIG. 2 also includes a primitives engine (258) implemented as computer program instructions that execute primitive query functions in dependence upon the access plan. A ‘primitive query function,’ or simply a ‘primitive,’ is a software function that carries out actual operations on a database, retrieving records from tables, inserting records into tables, deleting records from tables, updating records in tables, and so on. Primitives correspond to parts of an access plan and are identified in the access plan. Examples of primitives include the following database instructions:
retrieve the next three records from the stores table into hash table H1
retrieve one record from the transactions table into hash table H2
join the results of the previous two operations
store the result of the join in table T1

The SQL module (260) of FIG. 2 also includes a query isolation and performance processing module (150). The query isolation and performance processing module (150) of FIG. 2 is capable of isolating database queries for performance processing according to the present invention. The query isolation and performance processing module (150) includes computer program instructions capable of presenting to a user a prioritized list of potentially poorly performing queries; receiving from the user a selection of one or more potentially poorly performing queries; and executing performance processing of the selected queries.

A prioritized list of poorly performing queries allows a user to select from the prioritized list one or more particular queries and execute performance processing on only the selected queries. The query isolation and performance processing module (150) therefore provides a user with the ability to monitor the performance and tune the performance in real time of select queries.

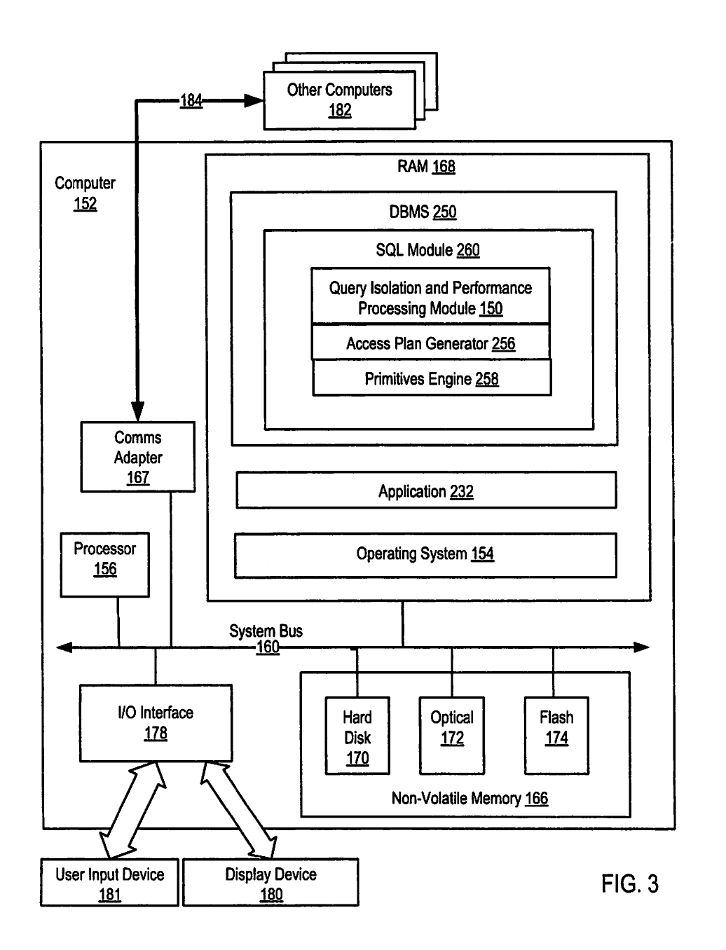

As mentioned above, isolating database queries for performance processing in accordance with the present invention is generally implemented with computers, that is, with automated computing machinery. For further explanation, FIG. 3 sets forth a block diagram of automated computing machinery comprising a computer (152) useful in isolating database queries for performance processing in accordance with the present invention according to embodiments of the present invention. The computer (152) of FIG. 3 includes at least one computer processor (156) or ‘CPU’ as well as random access memory (168) (“RAM”). Stored in RAM (168) is database management system (250). The database management system (250) of FIG. 3 includes an SQL module (260), which in turn includes an access plan generator (256) and a primitives engine (258).

The SQL module (260) of FIG. 3 also includes a query isolation and performance processing module (150). The query isolation and performance processing module (150) of FIG. 2 is capable of isolating database queries for performance processing according to the present invention. The query isolation and performance processing module (150) includes computer program instructions capable of presenting to a user a prioritized list of potentially poorly performing queries; receiving from the user a selection of one or more potentially poorly performing queries; and executing performance processing of the selected queries.

A prioritized list of poorly performing queries allows a user to select from the prioritized list a particular query and execute performance processing on only the selected queries. The query isolation and performance processing module (150) therefore provides a user with the ability to monitor the performance and tune to performance in real time of select queries.

Also stored in RAM (168) is an application (232), a computer program that uses the DBMS (250) to access data stored in a database. Also stored in RAM (168) is an operating system (154). Operating systems useful in computers according to embodiments of the present invention include Unix, Linux, Microsoft NT™, i50S, and many others as will occur to those of skill in the art. Operating system (154), DBMS (250), and application (154) in the example of FIG. 3 are shown in RAM (168), but many components of such software typically are stored in non-volatile memory (166) also.

The computer (152) of FIG. 3 includes non-volatile computer memory (166) coupled through a system bus (160) to processor (156) and to other components of the computer. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary computer (152) of FIG. 3 includes a communications adapter (167) for implementing connections for data communications (184), including connections through networks, to other computers (182), including servers, clients, and others as will occur to those of skill in the art. Communications adapters implement the hardware level of connections for data communications through which local devices and remote devices or servers send data communications directly to one another and through networks. Examples of communications adapters useful according to embodiments of the present invention include modems for wired dial-up connections, Ethernet (IEEE 802.3) adapters for wired LAN connections, and 802.11b adapters for wireless LAN connections.

The example computer of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

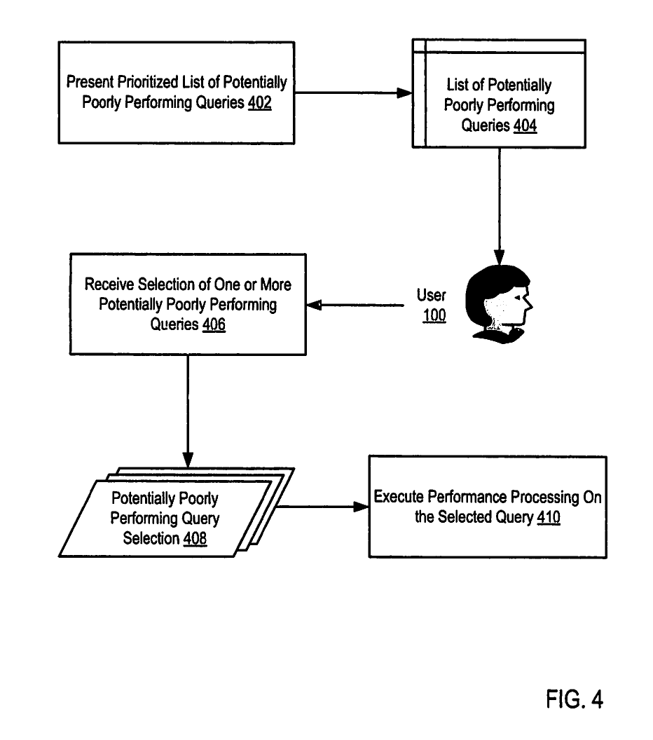

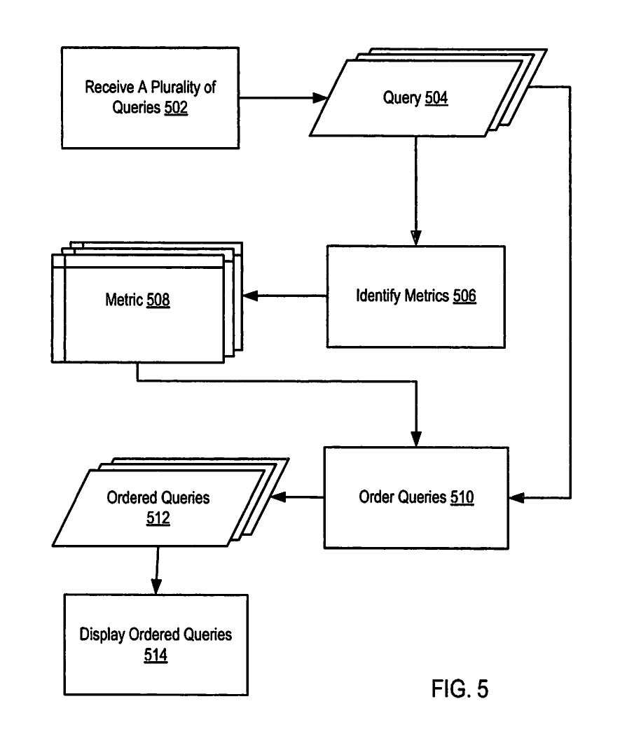

For further explanation, FIG. 4 sets forth a flow chart illustrating an exemplary method for isolating database queries for performance processing according to embodiments of the present invention. The method of FIG. 4 includes presenting (402) to a user (100) a prioritized list (404) of potentially poorly performing queries. Presenting (402) to a user (100) a prioritized list (404) of potentially poorly performing queries may be carried out by displaying a prioritized list of potentially poorly performing queries to a user and providing a graphical user interface for a user to select one or more queries for performance processing. Presenting to a user a prioritized list of potentially poorly performing queries may be carried out by receiving a plurality of queries; identifying one or more metrics describing the queries; ordering the queries in dependence upon the metrics; and displaying the ordered queries as discussed below with reference to FIG. 5.

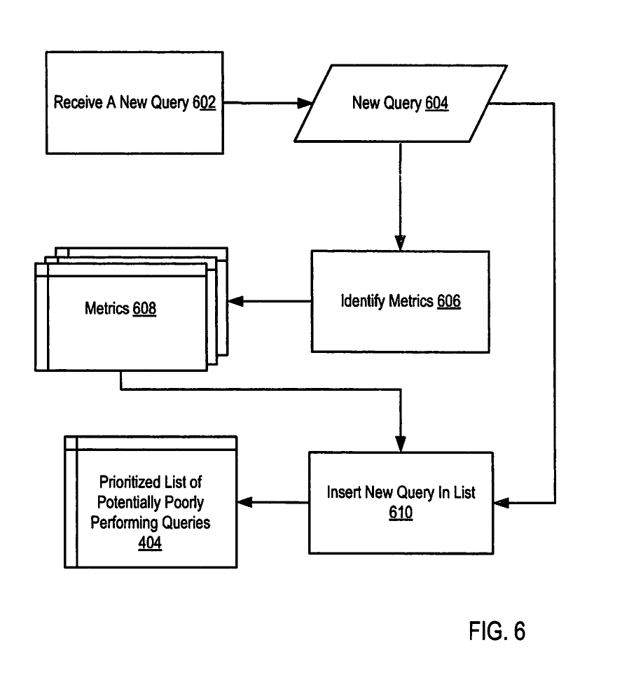

Once a prioritized list of potentially poorly performing queries is created, that list may be updated query by query. Presenting to a user a prioritized list of potentially poorly performing queries that updates an existing list may therefore may also be carried out by receiving a new query; identifying one or more metrics describing the new query; and inserting the query in a prioritized list of queries in dependence upon the metrics as discussed below with reference to FIG. 6.

The method of FIG. 4 also includes receiving (406) from the user (100) a selection of one or more potentially poorly performing queries (408). Receiving (406) from the user (100) a selection of one or more potentially poorly performing queries (408) may be carried out by receiving a user selection of one or more queries through a graphical user interface (‘GUI’).

The method of FIG. 4 also includes executing (410) performance processing of the selected queries (408). As mentioned above, executing performance processing of the selected queries may be carried out by executing performance analysis of the selected queries. Executing performance processing of the selected queries may also be carried out by executing performance tuning of the selected queries.

Executing (410) performance processing of the selected queries (408) may be carried out in real time when the selected query is run. In such cases, identifications of the selected queries are maintained and each query received is compared to the selected queries. If the received query matches a user selected query then performance processing on the received query is executed. The comparison between each received query and identifications of those selected by a user may be carried out at SQL Open for each query and performance processing of the selected query may be ended at SQL close.

In some cases, once a user has selected one or more queries no further user intervention is required. Executing performance processing of the selected queries may be carried out in such case by receiving the selected query and executing a performance processing tool for the selected query without further user intervention.

Alternatively, a user may wish be notified when a selected query is run. Executing performance processing of the selected queries may be carried out in these situations by receiving the selected query and prompting the user for an instruction to execute a performance processing tool for the selected query. Prompting the user for an instruction to execute a performance processing tool for the selected query provides to a user real time notification of the receipt of the query and provides a user the option of a user to determine whether to execute the performance processing.

Executing (410) performance processing of the selected queries may be carried out by executing performance analysis of the selected queries. Executing performance analysis of the selected queries (408) may be carried out by running a performance analysis tool on the selected queries. Examples of performance analysis tools useful in accordance with the present invention include IBM's Visual Explain, Microsoft's SQL Profiler, and others as will occur to those of skill in the art. Visual Explain, for example, is a database tool that graphically represents the implementation of a query request. Visual Explain provides a method of identifying and analyzing database performance problems. The implementation of a query is broken down into the individual element of an access path and organized in a tree structure. The resulting tree (made up of these base components) provides a visual explanation of the implementation of a query. Other examples of performance analysis tools useful in accordance with the present invention include Microsoft's SQL Profiler, and others as will occur to those of skill in the art.

Executing performance processing of the selected queries further may also be carried out by executing performance tuning of the selected queries. Executing performance tuning of the selected queries may be carried out by providing hints through a DBMS function, such as for example, a Change Query Attributes or CHGQRYA options for the selected query. Such hints may include instructions to use different indexes. Performance tuning may also include changing environmental conditions, modifying an access plan, creating statistics, creating indexes, and others as will occur to those of skill in the art.

Executing performance processing of the selected queries therefore often leaves other unselected queries to operate without interruption or change. That is, the queries not selected may continue to operate as usual and are unaffected by the method of FIG. 4. As such, performance tuning of a selected query, for example, may be isolated from queries not selected such that the unselected query is unaffected by the performance tuning.

For further explanation, FIG. 5 sets forth a flow chart illustrating an exemplary method for presenting to a user a prioritized list of potentially poorly performing queries that includes receiving (502) a plurality of queries (504). Receiving (502) a plurality of queries (504) may be carried out by retrieving queries from a query plan cache, SQL Package, or program object with embedded SQL or database monitor.

The method of FIG. 5 also includes identifying (506) one or more metrics (508) describing the queries (504). Many different metrics may be used to order the queries. Examples of such metrics include absolute performance, performance relative to other runs of the same query, amount of temporary storage used, number of IOs issued, cumulative runtime, number of access plan rebuilds, number of Full Opens as opposed to pseudo opens, age of the query, number and type of negative SQL codes returned from the query, and others as will occur to those of skill in the art.

The method of FIG. 5 also includes ordering (510) the queries (504) in dependence upon the metrics (508). Ordering (510) the queries (504) in dependence upon the metrics (508) may be carried out by sorting the queries in dependence upon the metrics. The queries may be ordered for example by worst to best thereby identifying the greatest potential problem queries at the top of the list.

A single metric may not be sufficient to accurately order the queries from greatest to least potentially poorly performing queries. In some cases, therefore, ordering (510) the queries (504) in dependence upon the metrics (508) may include a weighted ordering scheme that prioritizes some metric types over others.

A raw metrics value may also be more useful when combined with the metric type. That is, metrics are more useful when taken in context of the actual query. Ordering (510) the queries (504) in dependence upon the metrics (508) therefore also may be carried out by ordering the queries in further dependence upon one or more attributes of the query. Such query types may include certain SQL operations such as SQL Open, SQL Pseudo Open, SQL Fetch, or others.

The method of FIG. 5 includes displaying (514) the ordered queries (512). Displaying (514) the ordered queries (512) may be carried out by providing the ordered queries in a prioritized list available for viewing by a user on for example a monitor. The ordered queries may also be displayed with additional graphics such as icons, color and so on to further identify the greatest potentially poorly performing queries.

As mentioned above, once a prioritized list of potentially poorly performing queries is created, that list may be updated query by query. For further explanation, FIG. 6 sets forth a flow chart illustrating an exemplary method for presenting to a user a prioritized list of potentially poorly performing queries that includes receiving (602) a new query (604), identifying (606) one or more metrics (608) describing the new query (604) and inserting (610) the query (604) in a prioritized list (404) of queries in dependence upon the metrics (608). Such new queries may be called ‘confessing queries’ because they are inserted in the position in the prioritized list of potentially poorly performing queries as they are received and their real time metrics ‘confess’ their position in the prioritized list of potentially poorly performing queries.

Exemplary embodiments of the present invention are described largely in the context of SQL. This is for ease of explanation and not for limitation. Isolating database queries for performance processing is not limited to SQL. In fact, other query languages exist such as XML, QRY/400, Open Query File (‘OPNQUERYF’), DLL and isolating database queries for performance processing may include queries of all such query languages and many others as will occur to those of skill in the art.

Exemplary embodiments of the present invention are described largely in the context of a fully functional computer system for isolating database queries for performance processing. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer implemented method for isolating database queries for performance processing, the method comprising:
presenting to a user a prioritized list of potentially poorly performing queries;
receiving from the user a selection of one or more potentially poorly performing queries; and
executing performance processing of the selected queries.

2. The method of claim 1 wherein presenting to a user a prioritized list of potentially poorly performing queries further comprises:
receiving a plurality of queries;
identifying one or more metrics describing the queries;
ordering the queries in dependence upon the metrics; and
displaying the ordered queries.

3. The method of claim 2 wherein ordering the queries in dependence upon the metrics further comprises ordering the queries in further dependence upon one or more attributes of the query.

4. The method of claim 1 wherein presenting to a user a prioritized list of potentially poorly performing queries further comprises:
receiving a new query;
identifying one or more metrics describing the new query; and
inserting the query in a prioritized list of queries in dependence upon the metrics.

5. The method of claim 1 wherein executing performance processing of the selected queries further comprises executing performance analysis of the selected queries.

6. The method of claim 1 wherein executing performance processing of the selected queries further comprises executing performance tuning of the selected queries.

7. A system for isolating database queries for performance processing, the apparatus comprising a computer processor, a computer memory operatively coupled to the computer processor, the computer memory having disposed within it computer program instructions capable of:
presenting to a user a prioritized list of potentially poorly performing queries;
receiving from the user a selection of one or more potentially poorly performing queries; and
executing performance processing of the selected queries.

8. The system of claim 7 wherein computer program instructions capable of presenting to a user a prioritized list of potentially poorly performing queries further comprise computer program instructions capable of:
receiving a plurality of queries;
identifying one or more metrics describing the queries;
ordering the queries in dependence upon the metrics; and
displaying the ordered queries.

9. The system of claim 8 wherein computer program instructions capable of ordering the queries in dependence upon the metrics further comprise computer program instructions capable of ordering the queries in further dependence upon one or more attributes of the query.

10. The system of claim 7 wherein computer program instructions capable of presenting to a user a prioritized list of potentially poorly performing queries further comprise computer program instructions capable of:
receiving a new query;
identifying one or more metrics describing the new query; and
inserting the query in a prioritized list of queries in dependence upon the metrics.

11. The system of claim 7 wherein computer program instructions capable of executing performance processing of the selected queries further comprise computer program instructions capable of executing performance analysis of the selected queries.

12. The system of claim 7 wherein computer program instructions capable of executing performance processing of the selected queries further comprise computer program instructions capable of executing performance tuning of the selected queries.

13. A computer program product for isolating database queries for performance processing, the computer program product disposed in a computer readable signal bearing medium, the computer program product comprising computer program instructions capable of:
presenting to a user a prioritized list of potentially poorly performing queries;
receiving from the user a selection of one or more potentially poorly performing queries; and
executing performance processing of the selected queries.

14. The computer program product of claim 13 wherein computer program instructions capable of presenting to a user a prioritized list of potentially poorly performing queries further comprise computer program instructions capable of:
receiving a plurality of queries;
identifying one or more metrics describing the queries;
ordering the queries in dependence upon the metrics; and
displaying the ordered queries.

15. The computer program product of claim 14 wherein computer program instructions capable of ordering the queries in dependence upon the metrics further comprise computer program instructions capable of ordering the queries in further dependence upon one or more attributes of the query.

16. The computer program product of claim 15 wherein computer program instructions capable of presenting to a user a prioritized list of potentially poorly performing queries further comprise computer program instructions capable of:
receiving a new query;
identifying one or more metrics describing the new query; and
inserting the query in a prioritized list of queries in dependence upon the metrics.

17. The computer program product of claim 13 wherein computer program instructions capable of executing performance processing of the selected queries further comprise computer program instructions capable of executing performance analysis of the selected queries.

18. The computer program product of claim 13 wherein computer program instructions capable of executing performance processing of the selected queries further comprise computer program instructions capable of executing performance tuning of the selected queries.

19. The computer program product of claim 13 wherein the computer readable signal bearing medium comprises a recordable medium.

20. The computer program product of claim 13 wherein the computer readable signal bearing medium comprises a transmission medium.
